(19) United States
(12) Patent Application Publication
(10) Pub. No.: US 2017/0061214 A1
(43) Pub. Date: Mar. 2, 2017

(54) CONTROLLING BANDWITH UTILIZATION OF VIDEO TRANSMISSIONS FOR QUALITY AND SCALABILITY

(71) Applicant: General Electric Company, Schenectady, NY (US)

(72) Inventors: Ching-Ling Huang, San Ramon, CA (US); Yoshifumi Nishida, San Jose, CA (US)

(21) Appl. No.: 14/841,419

(22) Filed: Aug. 31, 2015

(51) Int. Cl. G06K 9/00; H04N 7/18; H04N 7/01; H04N 5/247

(52) U.S. Cl. CPC G06K 9/00711; H04N 5/247; G06K 9/00255; G06K 9/00315; H04N 7/181; H04N 7/0117

(57) ABSTRACT

A method of managing bandwidth associated with video transmissions over a computer network is disclosed. A plurality of video transmissions is received from a plurality of video cameras connected to a computer surveillance system via the computer network. Quality levels of the plurality of video transmissions are set to a first level. A first analysis is performed on a video transmission to identify whether a region of interest exists. A quality level of the video transmission is increased to a second level with respect to the region of interest. A second analysis is performed on the region of interest to identify whether an actionable event has occurred in an area monitored by one of the plurality of video cameras. The quality level may subsequently be restored to the first level to keep usage of the bandwidth efficient and scalable for a large number of camera nodes.

### TECHNICAL FIELD

The present application relates generally to the technical field of computerized video surveillance systems, and, in one specific example, to dynamically adjusting the quality of a region of a video transmission to improve automatic detection of a possible occurrence of an actionable event in an area monitored by a video camera corresponding to the video transmission.

### BACKGROUND

Video surveillance systems may have various uses, including improving security at residential homes, neighborhoods, or industrial systems or facilities, such as factories, warehouses, manufacturing facilities, generating stations, power plants, powerhouses, or generating plants. Such video surveillance systems may include two or more computerized digital video cameras connected to each other or one or more additional computerized systems via a computer network. The video transmissions may then be transferred over the computer network, consuming at least some of the available bandwidth on the computer network.

### BRIEF DESCRIPTION OF THE DRAWINGS

Some embodiments are illustrated by way of example and not limitation in the figures of the accompanying drawings.

FIG. 1 is a network diagram depicting a client-server system within which various example embodiments may be deployed.

FIG. 2A is a block diagram illustrating multiple server applications that, in various example embodiments, are provided as part of the networked system of FIG. 1.

FIG. 2B is a block diagram illustrating client application that, in various example embodiments, are provided as part of the networked system of FIG. 1.

FIG. 2C is a block diagram illustrating client administration application(s).

FIG. 3 is a block diagram illustrating an example method of controlling the level of quality of video transmissions or regions of video transmissions to increasing the probability of identifying an occurrence of a potential actionable event while minimizing network bandwidth usage.

FIG. 4 is a block diagram illustrating an example method of adjusting the level of quality of video transmissions at a camera client node based on instructions received from a video surveillance system server node.

FIG. 5 is a block diagram illustrating interactions between a server node (e.g., one of the application servers of FIG. 1) and a camera node (e.g., one of the client camera systems of FIG. 1).

FIG. 6 is a block diagram illustrating an example user interface depicting video transmissions received from two cameras of the video surveillance system.

FIG. 7 is a block diagram of machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

Video surveillance systems may be used for a variety of purposes, including detecting occurrence of actionable events (e.g., threats) in a monitored environment in real time, such as an intrusion, theft, fire, flood, explosion, injury, sickness, equipment failure or malfunction, and so on. In various embodiments, the occurrence of such potential actionable events may be detected automatically by one or more applications executing on various nodes within a networked computer system. Based on the automatic detection of the occurrence of the actionable event, the system may perform a predetermined action in real time to respond to the actionable event (e.g., to mitigate or assist in mitigation of the threat) or notify an operator of the system of the occurrence of the potential actionable event via a user interface such that the operator may take steps in response to the detection of the actionable event.

The nodes of the networked computerized system may include one or more nodes corresponding to video cameras (e.g., wired or wireless digital video cameras) and one or more nodes corresponding to computerized video processing systems that are interconnected via a computer network. The cameras may be controllable remotely via one or more applications. For example, instructions may be sent from an application executing on a server node to an application executing on a camera node to cause the camera to pan, tilt, or zoom. Additionally, in various embodiments, instructions may be sent to the camera nodes to control the quality of the video that is transmitted from the camera node, thus controlling the amount of bandwidth that video transmissions from the video camera consume of the available bandwidth on the computer network. In various embodiments, the quality of the video may be controlled on a per camera basis to balance the need for adequate quality of video to assess potential actionable events through video analytics with the need to keep the bandwidth requirements within the available bandwidth or the need to reduce network usage charges imposed by a carrier network.

The quality of the video may be measured using objective quality metrics, including, for example, full reference (FR) methods, reduced reference (RR) methods, no-reference (NR) methods. NR methods may include pixel-based (NR-P) methods, parametric/bitstream (NR-B) methods, or hybrid (Hybrid NR-P-B) methods. Metrics may include signal-to-noise ratio (SNR), peak signal-to-noise ratio (PSNR), structural similarity (SSIM), multi-scale structural similarity (MS-SSIM), visual information fidelity, pixel domain version (VIFp), peak signal-to-noise ratio raking into account contrast sensitivity function (PSNR-HVS), peak signal-to-noise ratio taking into account contrast sensitivity function and between-coefficient contrast masking of DCT basis functions (PSNR-HVS-M), UQI, VQM, PEVQ, VQuad-HD, and CZD. Other metrics may include standardized metrics, such as ITU-T Rec. J.245 (RR), 2008; ITU-T J.247 (FR), 2008; ITU-T Rec. J.341 (FR), 2011; ITU-T Rec. J.342 (RR), 2011; and ITU-T Rec. P.1201 and P.1202.

In various embodiments, instructions may be sent to a camera node to set various parameters pertaining to the quality of the video transmissions that are subsequently sent from the video camera over the computer network. The settings of the parameters may, in turn, affect the quality of the video transmissions and the bandwidth consumed by the video transmissions. Such parameters may include, for example, the resolution, the bit-per-pixel (bit/pixel), the frames per second (FPS), pixel aspect ratio (PAR), audio encoding (e.g., MP3, Vorbis, or AAC), the video encoding (H.264 or VP8), and so on, for the video. In various embodiments, such parameters may configure a container bitstream (e.g., MP4, FLV, WebM, ASF, or ISMA), transport protocol (e.g., MMS, RTP, HLS, MPEG-DASH), or control protocol (e.g., MMS or RTSP) used to transmit the video. In various embodiments, such parameters may include quality of service (QoS) settings associated with the video transmission or a region of the video transmission. In various embodiments, such parameters may include codec settings for codecs on the camera node, such as a smart video codec for detecting facings in a video source, as described in more detail below.

In various embodiments, applications executing on a server node and a camera node may be configured to control a level of quality of a region within a video transmission separately from the quality of the rest of the video transmission. Thus, a region of interest within a video transmission may be identified for assigning of a higher quality and greater bandwidth usage, whereas the rest of the video transmission is assigned a lower quality and lower bandwidth usage.

By limiting the transmission of higher quality video to particular video transmissions or regions within the various video transmissions (e.g., video streams) from the various video cameras in the network, the bandwidth usage of the cameras may be reduced. Thus, for example, in various embodiments, additional cameras may be added to the video surveillance system without a quality of service of the video transmissions falling below a predetermined level.

In various embodiments, a method of managing bandwidth associated with video transmissions over a computer network is disclosed. A plurality of video transmissions is received from a plurality of video cameras connected to a computer surveillance system via the computer network. Quality levels of the plurality of video transmissions are set to a first level to limit consumption by the plurality of video transmissions of bandwidth available on the computer network. A first analysis is performed on a video transmission of the plurality of video transmissions to identify whether a region of interest exists. Based on a region of interest existing within the video transmission, a quality level of the video transmission is increased to a second level with respect to the region of interest. A second analysis is performed on the region of interest to identify whether a potential actionable event is occurring in an area monitored by one of the plurality of video cameras.

In various embodiments, one or more modules incorporated into a networked system to perform one or more of the various operations described herein, the one or more modules being implemented by one or more processors of a networked system. In various embodiments, instructions corresponding to one or more of the various operations herein may be included on a machine readable medium. The instructions may cause a machine to perform the various operations when executed by one or more processors of the machine.

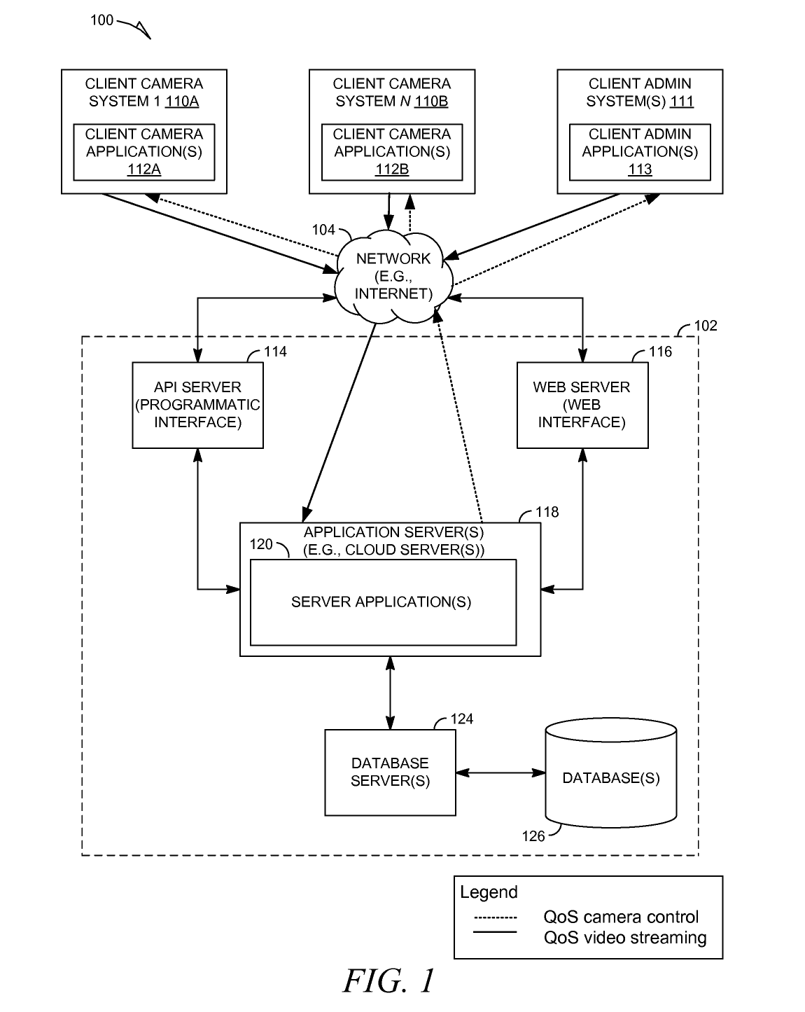

FIG. 1 is a network diagram depicting a system 100, in the example form of a computerized video surveillance system, within which various example embodiments may be deployed. A networked system 102, in the example form of a cloud-based video analytics system, provides server-side functionality, via a network 104 (e.g., the Internet or Wide Area Network (WAN)) to one or more client machines 110A and 110B (e.g., one or more video camera systems) and one or more client administration machines 111. FIG. 1 illustrates one or more client application(s) 112A and 112B executing on the client machines 110A and 110B and one or more client administration applications 113 executing on the client administration systems 111. Examples of client application(s) 112, 112B, and 113 may include a web browser application, such as the Internet Explorer browser developed by Microsoft Corporation of Redmond, Wash., or any other application supported by an operating system of the client machines 110A, 110B, and 111, such as Windows, iOS or Android operating systems. Each of the client application(s) 112A, 112B, and 113 may include one or more software application modules, including a plug-in, add-in, or macro that adds a specific service or feature to the client applications or the networked system 102.

An API server 114 and a web server 116 are coupled to, and provide programmatic and web interfaces respectively to, one or more application servers 118. The application servers 118 host one or more server application(s) 120. The application servers 118 are, in turn, shown to be coupled to one or more database servers 124 that facilitate access to one or more databases 126 or data stores, such as NoSQL or non-relational data stores.

The server applications 120 may provide a number of functions and services to one or more systems and one or more users that access the networked system 102. In various embodiments, the services may include Quality of Service (QoS) video streaming and QoS camera control, as described in more detail below.

While the applications 120 are shown in FIG. 1 to form part of the networked system 102, in alternative embodiments, the various applications 120 may form part of a service that is separate and distinct from the networked system 102.

Further, while the system 100 shown in FIG. 1 employs a client-server architecture, various embodiments are, of course, not limited to such an architecture, and could equally well find application in a distributed, or peer-to-peer, architecture system, for example. The various server applications 120 could also be implemented as standalone software programs, which do not necessarily have networking capabilities. Additionally, although FIG. 1 depicts machines 110A, 110B, and 111 as being coupled to a single networked system 102, it will be readily apparent to one skilled in the art that client machines 110A, 110B, and 111, as well as client applications 112A, 112B, and 113 may be coupled to multiple networked systems, such as networked systems associated with one or more industrial systems.

Web applications executing on the client machine(s) 110A, 110B, and 111 may access the various applications 120 via the web interface supported by the web server 116. Similarly, native applications executing on the client machine(s) 110A, 110B, and 111 may accesses the various services and functions provided by the applications 120 via the programmatic interface provided by the API server 114. For example, the third-party applications may, utilizing information retrieved from the networked system 102, support one or more features or functions on a website hosted by the third party.

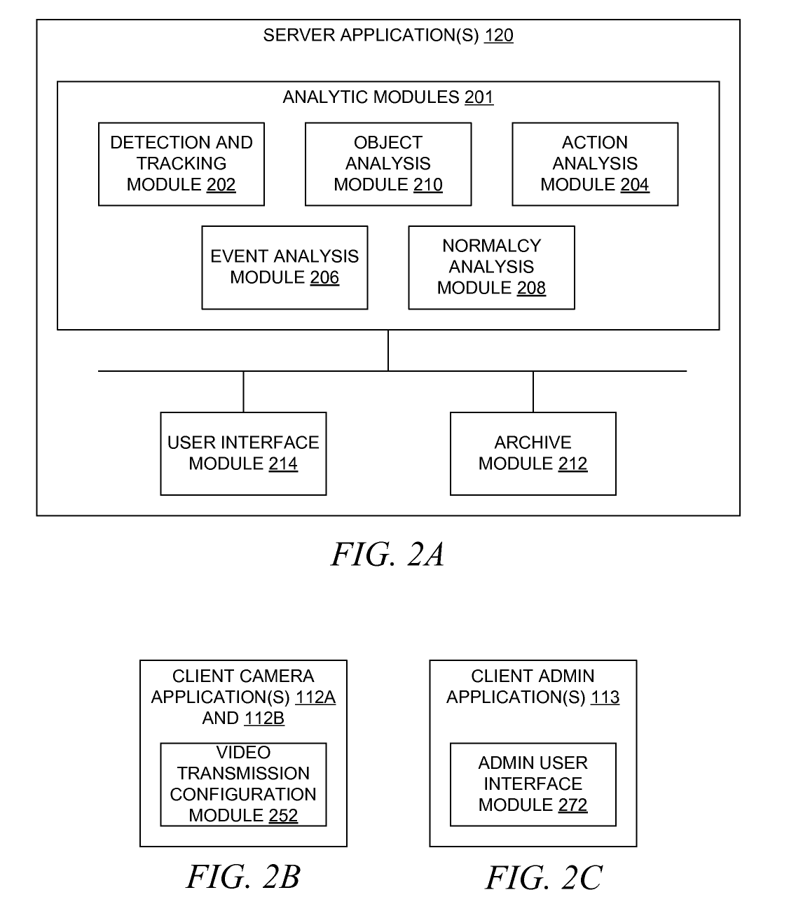

FIG. 2A is a block diagram illustrating one or more server applications 120 that, in various example embodiments, are provided as part of the networked system 102. The server applications 120 may be hosted on dedicated or shared server machines (not shown) that are communicatively coupled to enable communications between server machines. The server applications 120 themselves are communicatively coupled (e.g., via appropriate interfaces) to each other and to various data sources, so as to allow information to be passed between the server applications 120 so as to allow the server applications 120 to share and access common data. The server applications 120 may furthermore access one or more databases 126 via the database servers 124.

Analytic modules 201 may include a detection and tracking module 202, an object analysis module 210, an action analysis module 204, an event analysis module 206, and a normalcy analysis module 208.

The detection and tracking module 202 is configured to detect objects within a video transmission, such human faces, pieces of operating equipment, structures (e.g., doorways, windows, and so on), light sources, and so on.

The action analysis module 204 is configured to detect actions within the video transmission, such as a movement of a person or object. The action analysis module 204 may be configured to identify a movement of a person as a sign or gesture.

The event analysis module 206 is configured to detect interesting events occurring within a video transmission, such as a person entering or leaving an area capture in a frame of the video.

The normalcy analysis module 208 is configured to detect anomalies within a video transmission. In various embodiments, the normalcy analysis module 208 is configured to compare video transmissions being received in real time with archived video transmissions of a particular location captured over a period of time. For example, the normalcy analysis module 208 may be configured to identify historical normal patterns associated with an area in a frame of the video transmission and identify whether currently streaming video matches the pattern.

The object analysis module 210 is configured to analyze interesting objects within the video transmission, such as operating equipment, human faces, and so on. Additionally, for example, the object analysis module 210 may be configured to identify human emotions (e.g., as conveyed by expressions on human faces).

An archive module 212 is configured to archive video transmissions corresponding to potential actionable events, such as identification of an occurrence of a potential actionable event in an area captured by a video camera (e.g., detection of smoke, fire, broken window, intruder, emotional distress, and so on). Video transmissions identified as corresponding to potential actionable events may be flagged as confirmed or dismissed by an operator of the video surveillance system as corresponding to an actual actionable event.

A user interface module 214 is configured to generate and communicate user interface for presentation to a user (e.g., an operator of the video surveillance system). In various embodiments, the user interface may present video feeds received from various cameras at varying levels of quality. Regions within the video feed may be enhanced relative to surrounding regions of the video feed. Additionally, different video feeds from different cameras may be associated with different levels of video quality, as described in more detail below.

FIG. 2B is a block diagram illustrating client camera application(s) 112A and 112B that, in various example embodiments, are provided as part of the networked system 102. A video transmission configuration module 252 may be configured to control a level of quality of a video transmission (e.g., by adjusting various parameters associated with the transmission), as described in more detail below.

FIG. 2C is a block diagram illustration client administration application(s) 113. An administration user interface module 272 may be configured to present an administrator with streaming recorded or live video feeds corresponding to video captured by one or more cameras, enhanced views of regions within the video feeds, real-time notifications pertaining to potential actionable events, and options for taking an action in response to the real-time notifications of the potential actionable events, as described in more detail below.

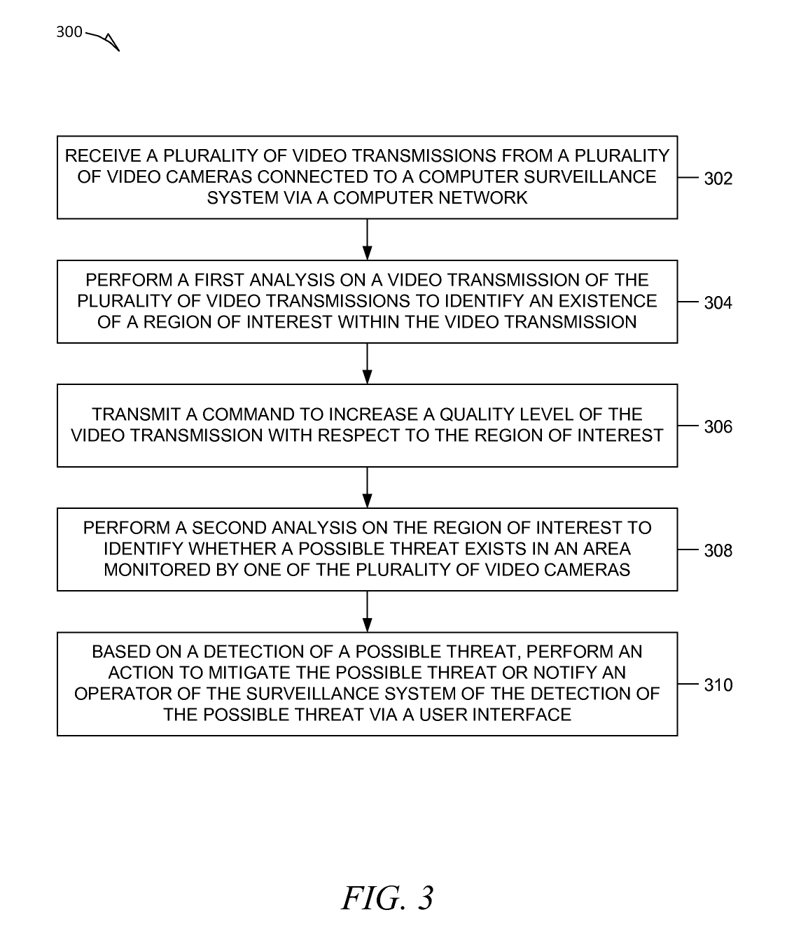

FIG. 3 is a block diagram illustrating an example method 300 of controlling the level of quality of video transmissions or regions of video transmissions to increase the probability of identifying an actionable event while minimizing network bandwidth usage. In various embodiments, the operations of method 300 may be implemented by one or more of the server applications 120.

At operation 302, the detection and tracking module 202 receives a plurality of video transmissions from a plurality of video cameras connected to a computer surveillance network.

At operation 304, the detection and tracking module 202 performs a first analysis on a video transmission of the plurality of video transmissions. The first analysis identifies whether a region of interest exists within the video transmission. A region of interest may be a region that corresponds to a movement or action within the video transmission (e.g., as identified by the action analysis module 204), an occurrence of an event within the video transmission (e.g., as identified by the event analysis module 206), an object within the video transmission (e.g., as determined by the object analysis module 210), or something abnormal occurring within the video transmission (e.g., as determined by the normalcy analysis module 208).

For example, the object analysis module 210 may determine that a region of the video transmission corresponds to a human face, an electrical panel, a light bulb, or any other object that has been useful in identifying potential actionable events in the past (e.g., based on archived data pertaining to video transmissions that preceded a positive identification of actual actionable events).

At operation 306, the detection and tracking module 202, based on a determination that the video transmission includes one or more regions of interest, the detection and tracking module 202 transmits an instruction or command to a camera node associated with the one of the plurality of video cameras. In various embodiments, the instruction instructs the video camera node to increase a quality level of the video transmission with respect to the one or more regions of interest.

At operation 308, the detection and tracking module 202 performs a second analysis on the one or more regions of interest. The second analysis identifies whether an actionable event is occurring in an area monitored by the one of the plurality of video cameras. In various embodiments, the second analysis is performed by comparing a segment of the video transmission with archived video transmissions corresponding to the region. For example, the second analysis may compare the higher quality video of a human face to archived higher quality videos of human faces to identify whether the human face is conveying a negative emotion, such as fear, sickness, shock, pain, distress, and so on. Or the second analysis may compare the higher video quality corresponding to an electrical object with archived video transmissions corresponding to the electrical object to determine whether the object is functioning normally.

At operation 310, based on a detection of an occurrence of a potential actionable event, the detection and tracking module 202 may perform an action automate a response to the detection. For example, based on a detection that a person has suffered an injury, the detection and tracking module 202 may automatically initiate an emergency response process (e.g., place a phone call to 911, a police department, or other emergency services). Or, based on a detection that an electrical object is smoking or on fire, the detection and tracking module 202 may automatically activate sprinklers in the area, initiate an automatic phone call to a fire department, and so on. Or, based on a detection that an intruder has entered a monitored area, the detection and tracking module 202 may automatically lock down a building, initiate an automatic call to a security service or police department, and so on. In various embodiments, the action automatically performed by the detection and tracking module 202 may be preconfigured by an administrator of the surveillance system. In various embodiments, the detection and tracking module 202 may notify an operator of the surveillance system of the occurrence of the potential actionable event (e.g., via the user interface module 214). The operator may then confirm the potential actionable event as an actual actionable event and take any additional necessary steps, such as those recommended by the detection and tracking module 202 based on a history of actions taken in response to the actionable event in the past.

Based on the identification of the potential actionable event as an actual actionable event or the dismissal of the potential actionable event as an actual actionable event (e.g., by an operator of the surveillance system), an archive of video transmissions may be updated such that future video transmissions having the similar video transmission characteristics may be identified more accurately based on the both the video transmissions used in the first analysis and second analysis. Thus, for example, video transmissions corresponding to the first analysis may be stored for future analysis of videos having a similar quality level and video transmission corresponding to the second analysis may also be stored for future analysis of videos having a similar increased quality level.

In various embodiments, additional operations may be performed to further enhance a region of the video (e.g., a region within an already enhanced region) and to perform further analysis on the multiply-enhanced region of the video such that potential actionable events may be identified with even more precision.

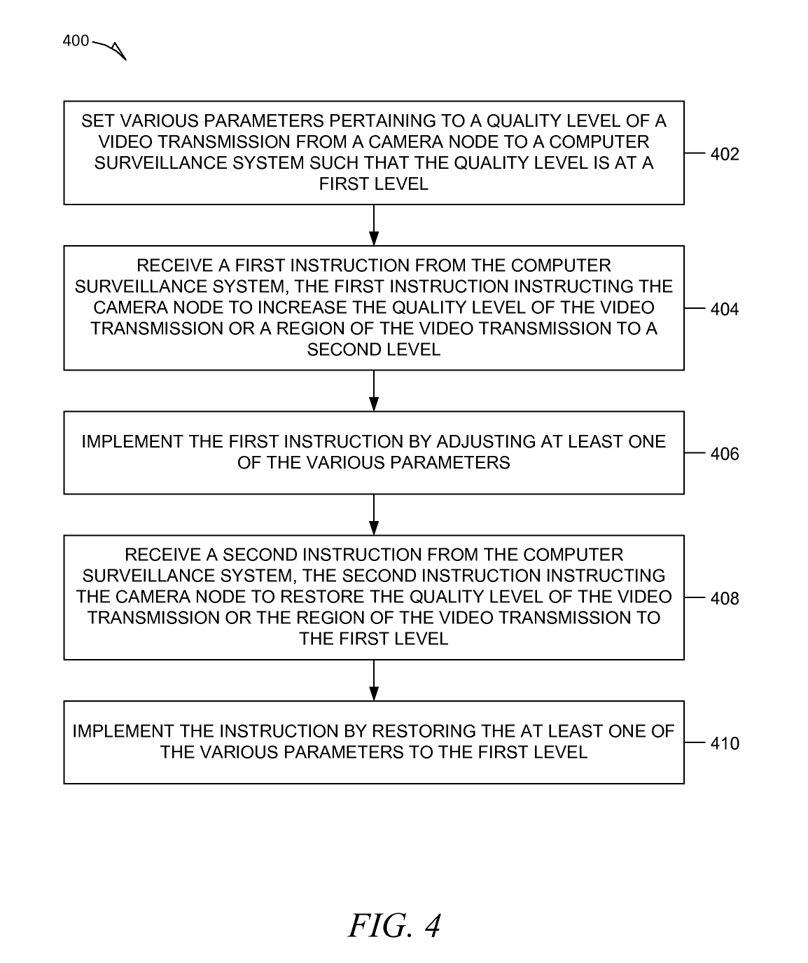

FIG. 4 is a block diagram illustrating an example method 400 of adjusting the level of quality of video transmissions at a camera client node based on instructions received from a video surveillance system server node. In various embodiments, the operations of method 400 may be implemented by one or more of the client applications 112A and 112B.

At operation 400, the video transmission configuration module 252 sets various parameters pertaining to a quality level of video transmissions that are to be transmitted from each camera node through the computer network. The parameters may be any of the parameters described above, such as a QoS setting, and may be different for each camera node. In various embodiments, the QoS setting for a particular camera node may control the priority of video transmissions from the camera node with respect to usage of the available computer network bandwidth.

As discussed above, another example of a configuration parameter may pertain to a smart video codec, such as a codec that looks for predefined points of interest. Such points of interest may include a human face (e.g., for detecting emotions) or a human arm (e.g., for detecting gestures). In various embodiments, video streaming of identified points of interest may be associated (e.g., encoded) with a higher QoS priority, resolution, and so on, while the rest of the frame may be associated with a normal (e.g., default or initial) level.

In various embodiments, an algorithm may look at (1) required frame quality for certain video transmissions or regions within video transmissions and (2) the overall network efficiency or performance requirements or constraints to determine first level parameter settings.

At operation 404, the video transmission configuration module 252 receives a first instruction or command from the computer surveillance system (e.g., from one of the server application(s) 120). The instruction instructs an associated camera node to increase the quality level of the video transmission or a region of the video transmission to a second level. In various embodiments, the second level specifies one or more values for one or more of the possible configuration parameters. The second level may be a lower quality level or a higher quality level in comparison to the first level. Thus, for example, the instruction may instruct the camera node to increase or decrease the QoS priority for the video transmission or a region of the video transmission.

At operation 406, the video transmission configuration module 252 implements the first instruction by setting the one or more configuration parameters to their new values.

At operation 408, the video transmission configuration module 252 receives a first instruction or command from the computer surveillance system (e.g., from one of the server application(s) 120). The second instruction instructs the associated camera node to restore the quality level of the video transmission or the region of the video transmission to the first level.

At operation 410, the video transmission configuration module 252 implements the first instruction by restoring the one or more configuration parameters to their initial values.

Thus, the video surveillance system may adjust the video transmissions from each of the camera nodes to get satisfactory quality for first-level analysis and second-level analysis given the available computer network bandwidth or network usage budget. Through this system, high-quality video feeds with an adaptive QoS setting are integrated with visual analytics to provide higher detection accuracy and network efficiency. In various embodiments, video feeds are kept in normal QoS priorities for baseline monitoring and only a fraction of are given higher QoS levels for video analytics to further inspect the high quality video or per-frame data to ensure detection performance and accuracy. The QoS assignment/adjustment can be triggered in real-time (e.g., when interesting events, human emotions, human signs, or human gestures are detected in the video feeds) to ensure a further video analysis is conducted with timeliness and higher quality.

In various embodiments, the system can archive accurate anomaly detection with large scale of cameras and high network congestion resiliency. The design also adjusts the QoS in real-time so that the video feeds can be provided as high quality as the event is happening to ensure the performance, monitoring, and detection precision of the video analytics. These features also make the framework scalable and able to support more video feeds over a network (e.g., a mobile network) simultaneously.

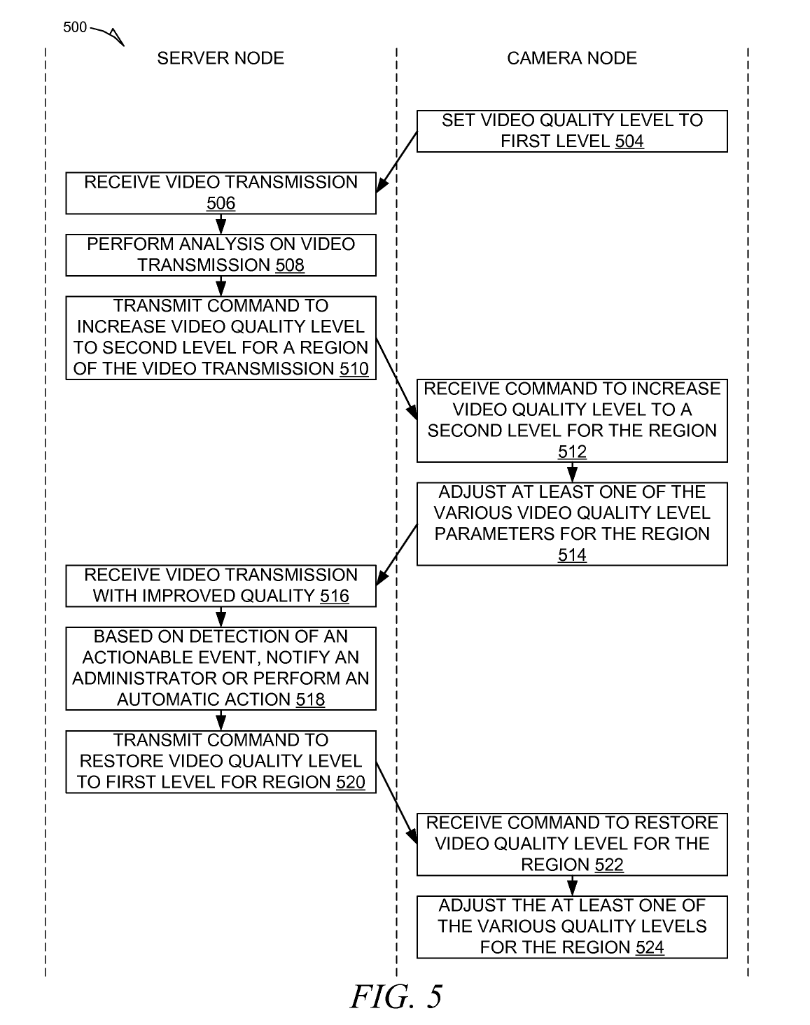

FIG. 5 is a block diagram illustrating interactions 500 between a server node (e.g., one of the application servers 118) and a camera node (e.g., one of the client camera system 1110A and the client camera system N 110B) of the networked system 100. At 504, the camera node sets a QoS level of video streaming from the camera node to a first level. In various embodiments, the first level may be determined automatically based on various factors, including an amount of bandwidth available on the network, a number of video cameras connected to the network, a cost of bandwidth usage to an entity managing the video surveillance system, a minimum QoS level required for a first video analytics pass (e.g., for detection of potential actionable events), and so on. In various embodiments, an administrator may set or change the QoS level manually (e.g., by adjusting various QoS parameters on a per-camera basis from the administration node).

At operation 506, the server node receives streaming video transmissions from the camera node.

At operation 508, server applications executing on the server node perform a first video analytics pass on the received streaming video to identify potential regions of interest within the video transmission.

At operation 510, the server node transmits a command to the camera node to increase the QoS level of the video transmission with respect to any identified potential regions of interest.

At operation 512, the camera node receives the command to increase the QoS level of the video transmission with respect to the region of interest.

At operation 514, one or more client applications executing on the camera node adjust one or more QoS parameters in order to increase the QoS level of the video transmission to a second level with respect to the region of interest.

At operation 516, the server node receives an additional video transmission from the camera node.

At operation 518, the server applications perform a second video analytics pass on the received streaming video, particularly the enhanced region, to detect whether an actionable event is occurring. Based on a detection of such an actionable event, the server applications perform a predetermined action in response to the detection. In various embodiments, the server applications notify an administrator of the detection. In various embodiments, the server applications generate suggestions of actions (e.g., based on historical analysis of previous detections of such actionable events) for the administrator to manually perform or otherwise initiate from within a user interface.

In various embodiments, if the second analytics pass is unable to identify whether an actionable event is occurring within the region of interest or not, steps 510-518 may be repeated with respect to the region of interest or an additional region within the region of interest. Thus, for example, a more and more particular region of the video transmission may be enhanced with greater and greater detail until the video analytics are able to ascertain with a degree of certainty whether the actionable event is occurring.

At operation 520, upon resolution of the detection of any actionable events (e.g., upon an action being taken in response to the detection or upon the dismissal of the event as a non-actionable event based on further video analytics processing, such as comparison of the enhanced region of the video transmission with video transmissions that were previously assessed and stored for comparison purposes in a data store of the video surveillance system, or based on input from an administrator), the camera node transmits a command to restore the video quality level to the first level with respect to the identified region of interest.

At operation 522, the camera node receives the command to restore the video quality level back to the first level.

At operation 524, one or more client applications executing on the camera node adjust various QoS parameters to restore the quality level of the video transmission back to the first level.

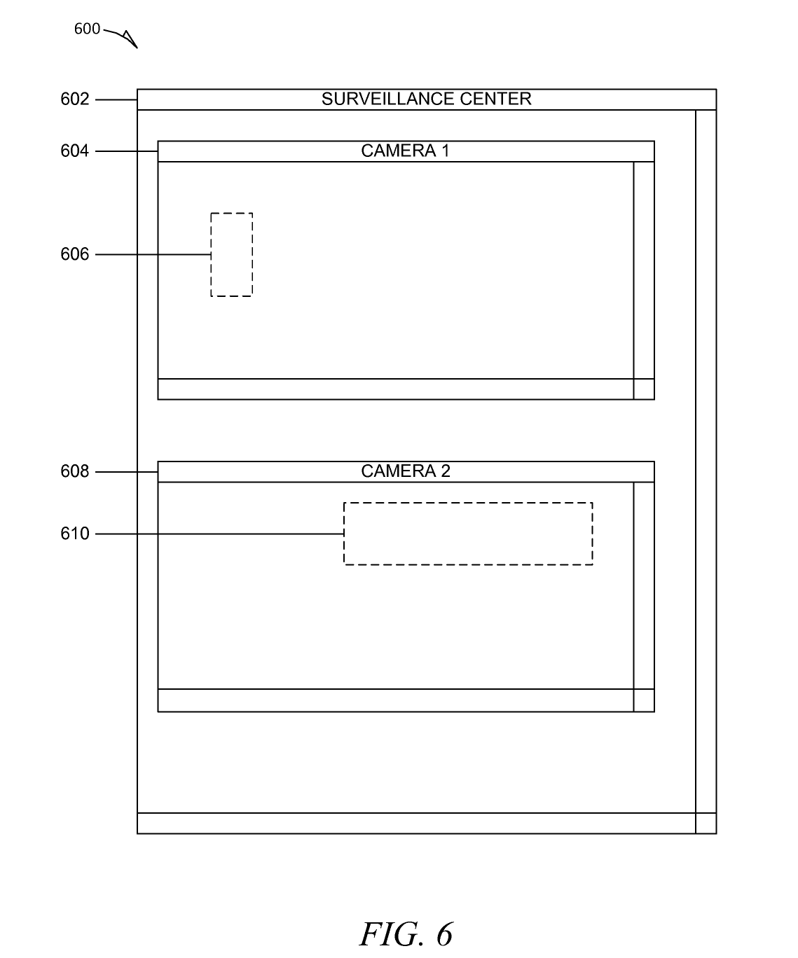

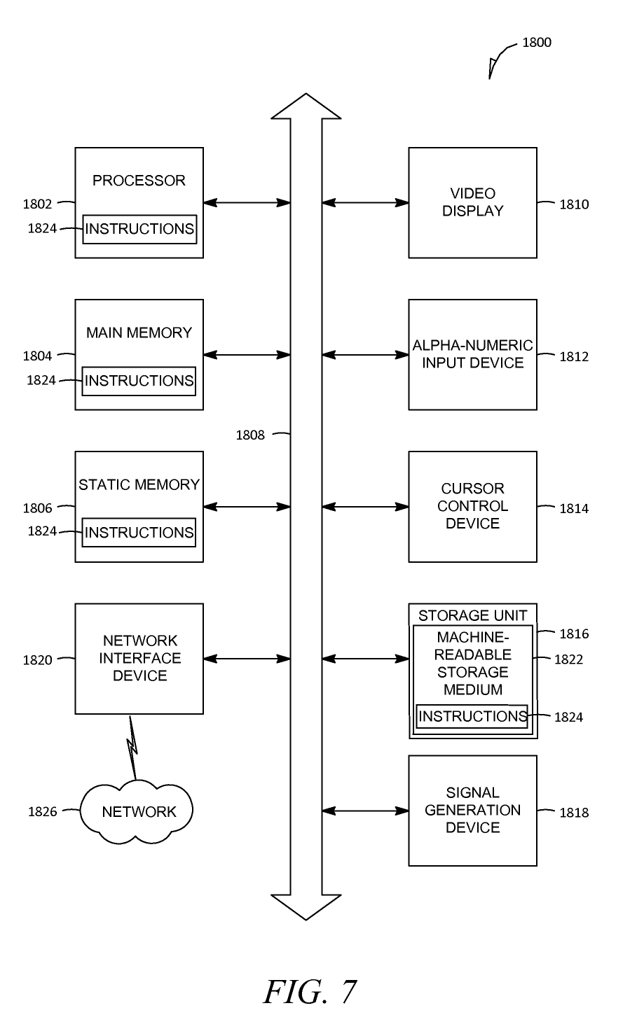

FIG. 6 is a block diagram illustrating an example user interface 600 depicting video transmissions received from two cameras of the video surveillance system. In various embodiments, the operations of method 600 may be implemented by one or more of the server application(s) 120 or the client admin application(s) 113.

The user interface includes a main window 602 that contains multiple camera windows 604 and 608. The camera window 604 may present a video feed received from a first one of the camera nodes (e.g., a first one of the client system(s) 110A and 110B) and the camera window 608 may present a video received from a second one of the camera nodes (e.g., a second one of the client system(s) 110A and 110B).

Each of the presented video feeds may have a separate level of quality. Additionally, each of the presented video feeds may have one or more regions having a higher level of quality than the surrounding regions in the same feed. For example, the region 606 in the camera window 604 represents a region of a video feed having a higher level of quality than the surrounding regions of the video feed. For example, the region 606 may correspond to a human face identified in the video feed. Because the region 606 has a higher quality than the surrounding regions of the video feed, the video surveillance system may be able to more accurately detect possible occurrence of actionable events within the region 606 than in the surrounding regions. Furthermore, an operator of the surveillance system may be able to discern the region 606 of the video feed with more clarity than the surrounding regions.

As another example, the region 610 represents a region of the video feed presented camera window 608 that has a higher level of quality than the surrounding regions of the video feed. For example, the region 610 may correspond to an object susceptible to fire or a window that is susceptible to intrusion.

In various embodiments, an alert may be presented to an operator of the surveillance system via the user interface 600 when an occurrence of a potential actionable event is detected. For example, the user interface may use audible or visual alarms to signal the location of the occurrence of the actionable event. For example, the region 606 or region 610 may be highlighted based on a detection of a possible occurrence of an actionable event within those regions.

The user interface 600 may include user interface elements (not shown) to allow an operator of the video surveillance system to confirm or dismiss an identified occurrence of a potential actionable event as an occurrence of an actual actionable event. Additionally, the user interface 600 may include options to assist the operator in taking actions to perform an action in response to the identification of the occurrence of the potential or actual actionable event or to configure the video surveillance system to perform particular actions automatically in response to the identification of the potential or actual actionable event.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a computer processor that is specially-configured using software, the computer processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

FIG. 10 is a block diagram of machine in the example form of a computer system 1800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU), a graphics processing unit (GPU) or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a user interface (UI) navigation (or cursor control) device 1814 (e.g., a mouse), a storage unit 1816, a signal generation device 1818 (e.g., a speaker) and a network interface device 1820.

The storage unit 1816 includes a machine-readable medium 1822 on which is stored one or more sets of data structures and instructions 1824 (e.g., software) embodying or utilized by any one or more of the methodologies or functions described herein. The instructions 1824 may also reside, completely or at least partially, within the main memory 1804 and/or within the processor 1802 during execution thereof by the computer system 1800, the main memory 1804 and the processor 1802 also constituting machine-readable media. The instructions 1824 may also reside, completely or at least partially, within the static memory 1806.

While the machine-readable medium 1822 is shown in an example embodiment to be a single medium, the term “machine-readable medium” may include a single medium or multiple media (e.g., a centralized or distributed database, and/or associated caches and servers) that store the one or more instructions 1824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices;
magnetic disks such as internal hard disks and removable disks; magneto-optical disks; and compact disc-read-only memory (CD-ROM) and digital versatile disc (or digital video disc) read-only memory (DVD-ROM) disks.

Accordingly, a “tangible machine-readable medium” may refer to a single storage apparatus or device, as well as “cloud-based” storage systems or storage networks that include multiple storage apparatus or devices. Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 1824 may further be transmitted or received over a communications network 1826 using a transmission medium. The instructions 1824 may be transmitted using the network interface device 1820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 1826 may be one of the networks 104.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
accessing, at a surveillance system, a plurality of video transmissions received from a plurality of video cameras connected to the computer surveillance system via a computer network, quality levels of the plurality of video transmissions being initially set to a first level to limit consumption of bandwidth available on the computer network;
performing a first analysis on a video transmission of the plurality of video transmissions, the first analysis identifying an existence of a region of interest within the video transmission;
transmitting a command to increase a quality level of the video transmission to a second level with respect to the region of interest; and
based on the quality level of the video transmission being increased to the second level, performing a second analysis on the region of interest, the second analysis identifying whether an actionable event has occurred in an area monitored by one of the plurality of video cameras corresponding to the video transmission.

2. The method of claim 1, further comprising, based on the second analysis identifying that the actionable event has occurred, enhancing a presentation of the one of the video transmissions within a user interface generated by the computer surveillance system.

3. The method of claim 2, further comprising transmitting a command to restore the quality level of the video transmission to the first level based on an input from the user of the computer surveillance system.

4. The method of claim 1, further comprising, transmitting a command to restore the quality level of the one of the video transmissions to the first level based on the second analysis identifying that the actionable event has not occurred in the area.

5. The method of claim 1, wherein the region of interest is a human face and the identifying of whether the actionable event has occurred is based on a matching of facial emotion recognition patterns to the human face.

6. The method of claim 1, wherein the region of interest is a region in which motion is identified and the identifying of whether the actionable event has occurred is based on a matching of previously-identified hazardous motions to the motion that is identified.

7. The method of claim 1, wherein the motion corresponds to one of a human gesture or a fire.

8. A surveillance system comprising:
one or more modules implemented by one or more processors, the one or more modules configured to:
receive a plurality of video transmissions from a plurality of video cameras connected to a computer surveillance system via a computer network, quality levels of the plurality of video transmissions being initially set to a first level to limit consumption of bandwidth available on the computer network;
perform a first analysis on a video transmission of the plurality of video transmissions, the first analysis identifying an existence of a region of interest within the video transmission;
transmit a command to increase a quality level of the video transmission to a second level with respect to the region of interest; and
based on the quality level of the video transmission being increased to the second level, perform a second analysis on the region of interest, the second analysis identifying whether an actionable event has occurred in an area monitored by one of the plurality of video cameras corresponding to the video transmission.

9. The system of claim 8, further comprising, based on the second analysis identifying that the actionable event has occurred, enhancing a presentation of the one of the video transmissions within a user interface generated by the computer surveillance system.

10. The system of claim 9, further comprising transmitting a command to restore the quality level of the video transmission to the first level based on an input from the user of the computer surveillance system.

11. The system of claim 8, further comprising, transmitting a command to restore the quality level of the one of the video transmissions to the first level based on the second analysis identifying that the actionable event has not occurred in the video transmission.

12. The system of claim 8, wherein the region of interest is a human face and the identifying of whether the actionable event has occurred is based on a matching of facial emotion recognition patterns to the human face.

13. The system of claim 8, wherein the region of interest is a region in which motion is identified and the identifying of whether the actionable event has occurred is based on a matching of previously-identified hazardous motions to the motion that is identified.

14. The system of claim 8, wherein the motion corresponds to one of a human gesture or a fire.

15. A non-transitory machine readable medium comprising a set of instructions that, when executed by a processor, causes the processor to perform operations, the operations comprising:
receiving a plurality of video transmissions from a plurality of video cameras connected to a computer surveillance system via a computer network, quality levels of the plurality of video transmissions being initially set to a first level to limit consumption of bandwidth available on the computer network;
performing a first analysis on a video transmission of the plurality of video transmissions, the first analysis identifying an existence of a region of interest within the video transmission;
transmitting a command to increase a quality level of the video transmission to a second level with respect to the region of interest; and
based on the quality level of the video transmission being increased to the second level, performing a second analysis on the region of interest, the second analysis identifying whether an actionable event has occurred in an area monitored by one of the plurality of video cameras corresponding to the video transmission.

16. The method of claim 15, further comprising, based on the second analysis identifying that the actionable event has occurred, enhancing a presentation of the one of the video transmissions within a user interface generated by the computer surveillance system.

17. The method of claim 16, further comprising transmitting a command to restore the quality level of the video transmission to the first level based on an input from the user of the computer surveillance system.

18. The method of claim 15, further comprising, transmitting a command to restore the quality level of the one of the video transmissions to the first level based on the second analysis identifying that the actionable event has not occurred in the video transmission.

19. The method of claim 15, wherein the region of interest is a human face and the identifying of whether the actionable event has occurred based on a matching of facial emotion recognition patterns to the human face.

20. The method of claim 15, wherein the region of interest is a region in which motion is identified and the identifying of whether the actionable event has occurred is based on a matching of previously-identified hazardous motions to the motion that is identified.
